(19) United States
(12) Patent Application Publication
(10) Pub. No.: US 2026/0277161 A1
(43) Pub. Date: Sep. 17, 2026

(54) HOROLOGY MOVEMENT FITTED WITH A BIDIRECTIONAL DRIVE MECHANISM FOR A JUMPING INDICATOR

(71) Applicant: ETA SA Manufacture Horlogère Suisse, Grenchen (CH)

(72) Inventor: Théo PENNINO, Nidau (CH)

(73) Assignee: ETA SA Manufacture Horlogère Suisse, Grenchen (CH)

(21) Appl. No.: 19/391,100

(22) Filed: Nov. 17, 2025

(30) Foreign Application Priority Data
Mar. 12, 2025 (EP) 25163329.3

(51) Int. Cl. G04B 19/02; G04B 13/02

(52) U.S. Cl. CPC G04B 19/02; G04B 13/025

(57) ABSTRACT

A horology movement is fitted with an indicator (4) and includes a mechanism (6) for driving this indicator in jumps in a first direction, the mechanism including a wheel plate (8) defining an axis of rotation, a rigid part (10) arranged above the wheel plate and forming a drive finger (12), and a spring having one end rotationally attached to the wheel plate and the other end rotationally attached to the rigid part, which is rotationally mobile relative to the wheel plate and runs through an opening (26) that enables the drive finger to be retracted towards the axis of rotation. The mechanism can drive the indicator in both directions and is arranged such that the spring contracts as it is being loaded in order to cause the indicator to jump in said first direction.

### CROSS-REFERENCE TO RELATED APPLICATIONS

This application claims priority to European Patent Application No. 25163329.3, filed on March 12, 2025, the entire contents of which are incorporated herein by reference.

### TECHNICAL FIELD OF THE INVENTION

The present invention relates to a horology movement comprising a jumping indicator and a bidirectional drive mechanism for this jumping indicator, as well as to a watch incorporating a horology movement fitted with such a bidirectional drive mechanism. In particular, the indicator is a date indicator. “Jumping” is taken to mean an indicator that indicates discrete values in jumps in a normal functioning direction of that indicator, that is, when it is driven by the horology movement in a given direction of an expected movement for the indicator. On the other hand, in the other direction of said movement, the drive can be non-jumping, or “dragging” as it is known in the horology industry. Thus, in the case of a date indicator, the movement is driven in semi-instantaneous or instantaneous jumps to indicate the succession of dates when the watch is running. However, when the date is corrected by a rotation in the opposite direction, the drive can generate a gain in the indicator per period but not necessarily per jump, which is referred to as “dragging.”

### TECHNOLOGICAL BACKGROUND

EP 3828644 describes a mechanism for driving a jumping indicator which remedies previous technical problems in that it comprises a rigid finger drum, rotationally and translationally guided by an arbor that runs through an oblong hole in the drum, and a spring arranged in this finger drum and rotationally attaching this finger drum to a wheel plate in which a drive couple is provided for the jumping indicator.

The aforementioned drive mechanism has a number of drawbacks. Firstly, the spring expands when the date disc is driven and its coil is designed to bear against the inside wall of the drum when the spring is being loaded, so as to limit the expansion of this spring and keep it from reaching the spring's plastic range. This results in an abrupt reduction in the active length of the spring. Given the manufacturing tolerances of the various elements, the loading time of the drive mechanism may vary, as the moment at which the spring comes into contact with the inner wall of the drum can vary from one loading to another and the angular position of the contact zone can also vary. This results in inaccurate timing of the release of the disc's transition to the next date. Another problem then arises from the fact that the drive force is transmitted to the finger via the coil of the spring, which for this purpose must therefore be sufficiently rigid/stiff over its entire length and more specifically over the portion between the contact zone on the wall of the drum and an organ for coupling to this drum arranged at the second end of the spring, this portion ultimately having to withstand the entire additional couple generated up to the moment the indicator jumps from the moment of contact.

A further problem with the mechanism in question results from the fact that, when the indicator is driven, the spring coil exerts a radial force on the drum that is directed outwards in a zone diametrically opposite the finger and therefore substantially in the longitudinal direction of the oblong hole, and that tends to move this finger away from the toothing on the disc. The finger is then more likely to move past a tooth without the indicator being driven, particularly if there is a slight shock in such a situation. It should also be noted that such a situation reduces the angular path over which the finger can drive a tooth while remaining in contact, such that the finger may move past the tooth before it receives a drive couple over a sufficient angular distance to ensure a date jump, the date disc remaining stopped in an intermediate position or returning to its previous stable position once the finger has moved past the tooth. Moreover, lowering the lever arm to apply the drive force to the tooth requires, for a given drive couple, an increase in the necessary drive force, which in turn requires an increase in the force provided by the spring and therefore in its tension.

In addition, the geometry of the coupling organ in relation to the bed machined in the drum wall, which allows for ample clearance and a certain amount of mobility of the coupling organ in the bed, creates another problem. In fact, when the spring is being loaded, this distorts the spring coil and causes the coupling organ to rotate on itself due to the ample angular clearance provided. This rotation will cause the coupling organ to slide against the front axial wall of the bed so that the point of application of the force from the spring on the finger drum is radially reduced as the spring is loaded. When the spring is loaded to a given level, the drive couple provided by the spring on the finger decreases in proportion to the lowering of the lever arm applying the force from the spring to the finger drum. This poses a problem because the drive force from the finger to the indicator tooth decreases in the same proportion for a given contact point. However, as a given drive couple is required to make the indicator jump, the spring will have to generate a force that is all the greater as said lever arm lowers while the spring is being loaded, which has a negative impact on the performance of the horology movement that loads the spring in the drive mechanism and then has to provide more couple. This also requires a spring with a more robust dimensioning than necessary.

Lastly, the aforementioned drive mechanism allows the indicator to be driven in one direction only. To drive the indicator in the opposite direction, in particular to make a correction to the display of this indicator, an additional mechanism is required, which makes the device for driving the indicator in both directions relatively complex and cumbersome.

### SUMMARY OF THE INVENTION

The invention aims to provide a mechanism for driving a jumping indicator that does not have the drawbacks of the prior art described above. The invention also aims to provide a mechanism for driving a jumping indicator that is efficient, can be accurate in each horology movement comprising such a mechanism, and is minimally or not at all disrupted in its functioning by external stresses such as shocks.

To this end, the invention relates to a horology movement fitted with an indicator and comprising a mechanism for driving this indicator in a first direction of the expected movement for the indicator, the drive being in jumps in the first direction, which corresponds to the direction of movement of the indicator when the horology movement is functioning normally. The mechanism comprises a wheel plate defining an axis of rotation, a rigid part arranged above the wheel plate and forming a drive finger configured to drive the indicator, and a spring comprising a coil and having a first end and a second end, the first end being rotationally attached to the wheel plate and the second end being rotationally attached to the rigid part at least when the spring is being loaded prior to a jump of the indicator in said first direction and then when the indicator is being driven by the drive finger to make this jump. The rigid part is rotationally mobile relative to the wheel plate and rotationally guided around said axis of rotation by an arbor aligned with this axis of rotation and running through an opening in the rigid part and that enables the drive finger to be retracted towards the axis of rotation under the action of a radial component of a force that can be exerted on this drive finger. According to the invention, the mechanism is arranged so as to be able to drive the indicator with the drive finger in said first direction and in a second direction, opposite to the first direction, of movement of the indicator when the wheel plate turns respectively in a first direction of rotation and the second direction of rotation. Moreover, the mechanism is arranged such that the spring contracts each time it is loaded in order to then cause the indicator to jump in said first direction. Moreover, the mechanism comprises a first stop rotationally attached to the wheel plate and a second stop rotationally attached to the rigid part at least each time the indicator is driven by the drive finger in said second direction, the mechanism being arranged such that the first stop causes the second stop to rotate each time the indicator is driven in said second direction by the drive finger, the first stop and the second stop thus limiting or preventing expansion of the spring. More specifically, when the drive finger is not in contact with the indicator, the initial angular distance between the first stop and the second stop is less than half of the normal angular travel of the second stop relative to the first stop when the spring contracts as it is being loaded in order to drive the indicator in said first direction.

In a preferred variant, the initial angular distance between the first stop and the second stop is less than a quarter of said angular path. In an advantageous variant, when the drive finger is not in contact with the indicator, the spring is substantially in its equilibrium position (no pre-tensioning by design).

Due to the aforementioned characteristics of the invention, the drive mechanism can drive the indicator in both directions, which is advantageous for enabling a user to quickly drive the indicator forwards and backwards, in particular via a control organ accessible on the outside of the watchcase, to make a correction to the display associated with the indicator; in other words, to the variable data indicated by the indicator. A remarkable feature is that in order to drive the indicator in jumps in said first direction (normal functioning direction), the spring coil contracts along its entire length for the duration of the spring loading and then causes the indicator to jump, thereby incrementing the indicator. In fact, the spring coil is left free to expand or contract throughout the loading process. Firstly, this contraction is much less critical, for the dimensions of the spring and the characteristics of the material forming it, than expansion as in the prior art in which only part of the coil is active in a terminal phase of the spring loading. Next, the duration of the spring loading, up to a given force couple to cause the indicator to jump, depends only on the spring itself, in particular on its stiffness. As long as the spring remains in its initial state and in particular with an invariable stiffness, the angular displacement between the two ends of the spring remains substantially invariable from one loading to the next, so that the loading time remains substantially invariable each time the spring is loaded and therefore the moment of each jump occurs at a given moment that remains accurate. In a preferred variant, the angular displacement is defined very precisely by a stop attached to the first end of the spring, against which a rigid part attached to the second end of the spring abuts. In addition, the contraction of the spring ensures a constant radius for the application of the drive force from the finger to the indicator tooth against which the finger bears, thereby optimising this drive force and consequently the drive couple provided to cause the indicator to jump. Lastly, due to the contraction of the spring, there is no need to provide for a wall around the spring to limit the expansion of the spring coil and also to significantly increase the force couple applied to the finger to release the indicator jump. The present invention therefore does not require a finger drum, although a finger drum is provided in one particular variant.

As explained above, the mechanism according to the invention is arranged so that the spring contracts each time it is being loaded so that the indicator can be driven in jumps in the first direction of the expected movement for the indicator, this first direction corresponding to the normal direction of movement of the indicator when the horology movement is functioning with no outside intervention (normal functioning). However, according to the invention, it is provided that the drive mechanism can also be used to drive the indicator in said second direction, which is opposite to the first direction of movement of the indicator. In said second direction in which the indicator is driven by the mechanism, with no specific measures, the spring would expand with a force couple exerted on it that would, in principle, be on the same order of magnitude as when driven in the first direction. In fact, since the force couple required to drive the indicator is determined in principle by a jumper spring that keeps the indicator in a stable position between successive jumps and generally has a similar intensity curve in both indicator drive directions, in the second direction, the jump drive would be similar to the drive in the first direction. Thus, the problem remedied by the invention for the drive in the direction occurring when functioning normally would, without the specific measures proposed by the invention, be present in the second direction in which the indicator is driven by the mechanism. In addition, the spring should be dimensioned so that it can function correctly, with no risk of deteriorating over time, over the entire range of contraction and expansion distortions. This makes it more complicated to manufacture the spring so that it can absorb such a load in both directions with no fatigue, and so that it does not break. To remedy this problematic situation and eliminate the drawbacks resulting therefrom, the mechanism according to the invention comprises a first stop rotationally attached to the wheel plate and a second stop rotationally attached to the rigid part at least each time the indicator is driven by the drive finger in said second direction, the mechanism being arranged such that the first stop causes the second stop to rotate each time the indicator is driven in said second direction by the drive finger, the first stop and the second stop thus limiting or preventing expansion of the spring. More specifically, the mechanism is arranged such that the initial angular distance between the first stop and the second stop, when the drive finger is not in contact with the indicator, is less than half of the normal angular travel of the second stop relative to the first stop when the spring is being loaded to drive the indicator in said first direction (normal functioning direction of the indicator, in which the indicator is jumping).

According to a main embodiment, the mechanism comprises a coupling organ that extends said coil on the side of the second end of the pring, which is thus defined by one end of this coil, and that is introduced at least partially into a bed in the rigid part, the coupling organ rotationally attaching the second end of the spring to the rigid part when the spring is being loaded and at least when the indicator is being driven in said first direction by the drive finger.

According to a first particular embodiment, said arbor is rotationally attached to the wheel plate and the coupling organ is rotationally attached to the rigid part when the indicator is driven in said second direction by the drive finger. Then, the first stop is made in one piece with or fastened to said arbor or with / to a central part rotationally attached to said arbor and the second stop is made in one piece with or fastened to the spring on the side of the second end of the spring or with / to the coupling organ.

According to a second particular embodiment, said arbor is rotationally attached to the wheel plate, the first stop is made in one piece with or fastened to the arbor or with/to a central part rotationally attached to this arbor, and the second stop is formed by the rigid part. According to an advantageous variant, the first stop is defined by the outer profile of a flange that forms one end of a central part, which forms the arbor rotationally attached to the wheel plate, and the second stop is formed by the profile of a recess in a plate forming the rigid part, the flange being located in the recess over at least part of its thickness.

According to a first general characteristic, said opening in the rigid part is an oblong hole machined in a plate forming this rigid part. According to a second general characteristic, the drive finger has two lateral flanks that are substantially radial and designed to be able to engage with a toothing comprised on the indicator, so as to be able to drive the indicator respectively in said first direction and said second direction.

### BRIEF DESCRIPTION OF THE FIGURES

The purposes, advantages and characteristics of the invention will be described in greater detail below with reference to the appended drawings, given by way of non-limiting examples, in which:

FIG. 1 is a top view of a horology mechanism, according to a first embodiment of the invention, designed to drive an indicator in jumps, particularly in semi-instantaneous jumps, in one direction and dragging in the other.

FIG. 2 is an exploded perspective view of the horology mechanism in FIG. 1.

FIG. 3 is a perspective view of a rigid part forming a drive finger and of the spring in the horology mechanism in FIG. 1, shown in an inverted position.

FIG. 4 is a view, similar to the one in FIG. 3, of part of a horology mechanism according to a first variant of the first embodiment of the invention.

FIG. 5 is a view, similar to the one in FIG. 3, of part of the horology mechanism according to a second variant of the first embodiment of the invention.

FIGS. 6A to 6D partially show a horology movement, incorporating the horology mechanism in FIGS. 1 to 3, respectively in four successive states occurring during a semi-instantaneous jump drive in a first direction, corresponding to the normal functioning direction, of a date disc by the horology mechanism.

FIGS. 7A and 7B partially show a horology movement incorporating the horology mechanism in FIGS. 1 to 3, respectively in two successive states occurring when the date disc is dragged in the second direction, opposite to the first direction.

FIGS. 8A and 8B partially show a horology movement incorporating the horology mechanism in FIGS. 1 to 3, respectively in two successive states occurring when the date disc is incorrectly positioned when the drive finger is rotated in the first direction.

FIGS. 9A and 9B partially show a horology movement incorporating the horology mechanism in FIGS. 1 to 3, respectively in two successive states occurring when the date disc is incorrectly positioned when the drive finger is rotated in the second direction.

FIG. 10 is a top view of a horology mechanism, according to a second embodiment of the invention, designed to drive an indicator in jumps, particularly in semi-instantaneous jumps, in one direction and dragging in the other.

FIG. 11 is an exploded perspective view of the horology mechanism in FIG. 10.

FIG. 12 is a perspective view of a rigid part forming a drive finger and of the spring in the horology mechanism in FIG. 10, shown in an inverted position.

FIG. 13 is a view, similar to the one in FIG. 12, of part of a horology mechanism according to a particular variant of the second embodiment of the invention.

FIGS. 14A to 14D partially show a horology movement, incorporating the horology mechanism in FIGS. 10 to 12, respectively in four successive states occurring during a semi-instantaneous jump drive in a first direction, corresponding to the normal functioning direction, of a date disc by the horology mechanism.

FIGS. 15A and 15B partially show a horology movement incorporating the horology mechanism in FIGS. 10 to 12, respectively in two successive states occurring when a date disc is dragged in the second direction, opposite to the first direction.

FIGS. 16A and 16B partially show a horology movement incorporating the horology mechanism in FIGS. 10 to 12, respectively in two successive states occurring when the date disc is incorrectly positioned when the drive finger is rotated in the first direction.

FIGS. 17A and 17B partially show a horology movement incorporating the horology mechanism in FIGS. 10 to 12, respectively in two successive states occurring when the date disc is incorrectly positioned when the drive finger is rotated in the second direction.

### DETAILED DESCRIPTION OF THE INVENTION

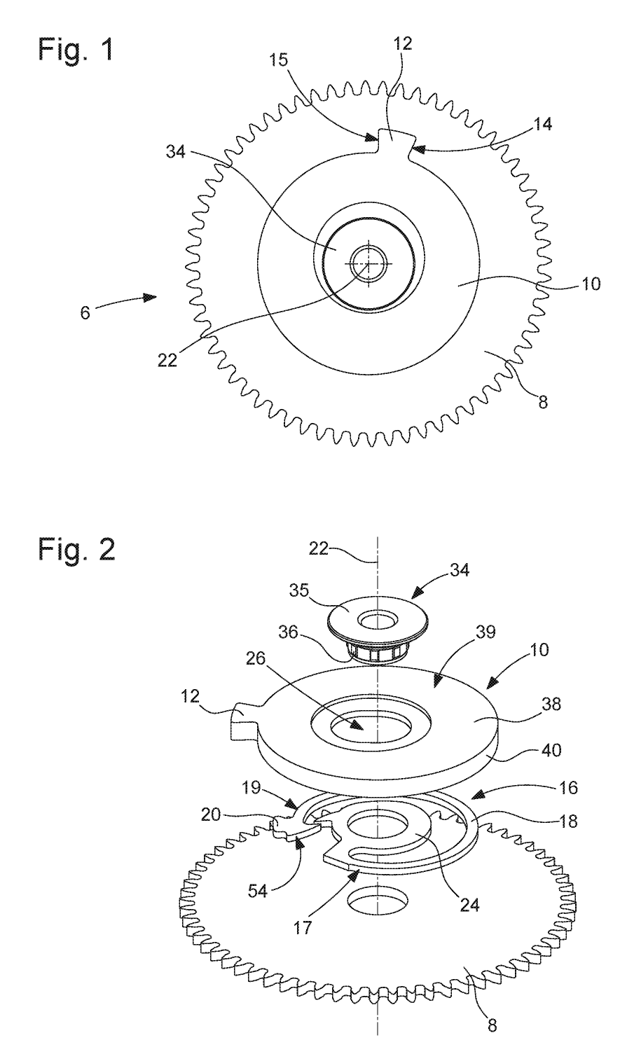

With reference to FIGS. 1 to 9B, a general embodiment of the invention will be described below, followed by a first embodiment of a mechanism for driving an indicator according to the invention and its function in both directions for driving this indicator. It should be noted that the characteristics of the general embodiment are, by definition, present in the first embodiment and also in the second embodiment, which will be described afterwards.

According to the general embodiment of the invention, which is described below with reference to various elements and parts of the first embodiment, which will be described more specifically thereafter, the horology movement 2 is fitted with an indicator 4 and comprises a mechanism 6 for driving this indicator in a first direction 30 and in a second direction, opposite to the first direction, of an expected movement for the indicator, this drive being in jumps in the first direction which corresponds to the direction of movement of the indicator when the horology movement 2 is functioning normally. It should be noted that the indicator can move in a variety of ways, in particular linearly or rotationally. The mechanism comprises a wheel plate 8 defining an axis of rotation 22, a rigid part 10 arranged above the wheel plate and forming a drive finger 12 configured to drive the indicator, and a spring 16 comprising a coil 18 and having a first end 17 and a second end 19, the first end being rotationally attached to the wheel plate 8 and the second end being rotationally attached to the rigid part 10 at least when the spring is being loaded prior to a jump of the indicator 4 in said first direction 30 and then when the indicator 4 is being driven by the drive finger 12 to make this jump. The rigid part 10 is rotationally mobile relative to the wheel plate 8 and rotationally guided around said axis of rotation 22 by an arbor 36 aligned with this axis of rotation and running through an opening 26 in the rigid part and that enables the drive finger 12 to be retracted towards the axis of rotation 22 under the action of a radial component of a force that can be exerted on this drive finger. The mechanism 6 is configured so as to be able to drive the indicator with the drive finger 12 in the first direction 30 and the second direction of movement of the indicator when the wheel plate turns respectively in a first direction of rotation 50 and the second direction of rotation. Then, the mechanism 6 is arranged such that the spring 16 contracts each time it is loaded in order to then cause the indicator to jump in the first direction. Moreover, the mechanism comprises a first stop 74 rotationally attached to the wheel plate and a second stop 76 rotationally attached to the rigid part at least each time the indicator 4 is driven by the drive finger 12 in said second direction. The mechanism 6 is arranged so that the first stop 74 rotates the second stop 76 each time the indicator is driven in said second direction, the first stop and the second stop thus limiting or preventing expansion of the spring 16, the initial angular distance θ between the first stop 74 and the second stop 76, when the drive finger is not in contact with the indicator, being less than half of the normal angular travel α of the second stop relative to the first stop when the spring contracts as it is being loaded in order to subsequently drive the indicator in jumps in the first direction 30 of its movement.

According to a first advantageous variant, when the drive finger 12 is not in contact with the indicator 4, the spring 16 is substantially in its equilibrium position (no pre-tensioning by design; only a residual stress due to friction between the spring and its support could potentially generate a low initial tension). In particular, the initial angular distance θ between the first stop and the second stop is intended to be non-zero, as is the case in the variants shown in the figures for the particular embodiments in question.

According to a first main variant, the drive finger 12 has two flanks 14 and 15 that are configured so as to engage with a toothing 5 on the indicator 4 to enable the indicator 4 to be driven respectively in the first direction 30 and the second direction. According to a second general variant, said opening is an oblong hole 26 machined in a plate 38 forming the rigid part 10. By way of non-limiting examples, the indicator is a jump-type minute, hour, date, day or month indicator.

In the first embodiment of a horology movement incorporating a mechanism 6 for driving an indicator according to the invention, the rigid part 10 is formed by a plate 38 that extends above the spring and in which an oblong hole 26 is machined, and an axial wall 40 arranged at the edge of this plate and which slopes away towards the wheel plate 8, on which it can rest in a main variant. Part of the axial wall 40 and part of the plate 38 superimposed thereon together form the drive finger 12, which has a height H extending at least from the underside of the spring 16 to the upper surface 39 of the plate. The rigid part 10 forms a finger drum that defines an inner space 11 in which the spring is between the wheel plate 8 and the plate 38 on the rigid part.

Near the drive finger 12, the axial wall 40 has a bed 42 with a lateral opening on the side of the inner space 11. The second end 19 of the spring 16 is extended by a coupling organ 20 for coupling to the rigid part 10, this coupling organ 20 being configured so as to be able to penetrate at least partially into the bed 42 and thus enable the spring to apply a drive force couple to the rigid part 10 in the first direction of rotation to enable the drive finger 12 to drive the date disc 4 in the first direction (normal direction). The mechanism 6 thus comprises a coupling organ 20 that extends the spring 16 on the side of its second end 19 and that is introduced at least partially into the bed 42 in the rigid part 10 so as to couple the spring to the rigid part, the coupling organ rotationally attaching the rigid part and the second end of the spring when the spring is being loaded and at least when the indicator 4 is driven in jumps in said first direction of rotation by the drive finger. Advantageously, the coupling organ 20 is rigid.

In a general variant, the arbor 36 is rotationally attached to the wheel plate 8 and the coupling organ 20 is rotationally attached to the rigid part 10 when the indicator 4 is driven in said second direction by the drive finger 12. Then, the first stop is made in one piece with or fastened to the arbor or with / to a central part rotationally attached to the arbor and the second stop is made in one piece with or fastened to the spring 16, on the side of its second end 19, or with / to the coupling organ. In a main variant, shown in the figures, the first stop 74 is made in one piece with the central part 24, which is rotationally attached to the wheel plate 8 via the arbor 36, and the second stop 76 is made in one piece with the coupling organ 20, which is rigid and rotationally attached to the rigid part 10 when the indicator 4 is rotated in said second direction by the drive finger. In an advantageous variant, also shown in the figures, the central part 24 and the coupling organ 20 are made in one piece with the spring 16 and together form a single part. The spring 16 is then formed by a single coil 18 that extends in a plane orthogonal to the axis of rotation 22, the two ends of the single coil thus defining the first end 18 and the second end 19 of the spring. It should be noted that the coil does not make a full turn in the advantageous example shown, but it is referred to as a “coil” in the present description and claims because of its general shape, which can be circular at rest in a specific case or have an expansion that does not show a gradual radial increase depending on the angle.

The mechanism 6 comprises a central part 34 comprising the arbor 36 that runs through the oblong hole 26 in the rigid part 10 and rotationally and translationally guides this rigid part relative to the wheel plate. In a particular variant, the wheel plate 8 and the central part 24 are driven in on the arbor 36, the central part 34 also comprising an annular flange 35 that forms an axial stop for the rigid part 10 on the side opposite the wheel plate 8. The drive finger 12 has two flanks 14 and 15 that are substantially radial, flank 14 being designed to drive the indicator 4, via its toothing 5, in the first direction of the rotational movement that this indicator can undergo (normal direction allowing successive and gradual display of the dates of the month), whereas flank 15 is designed to drive the indicator 4, via its toothing 5, in the second direction of this rotational movement.

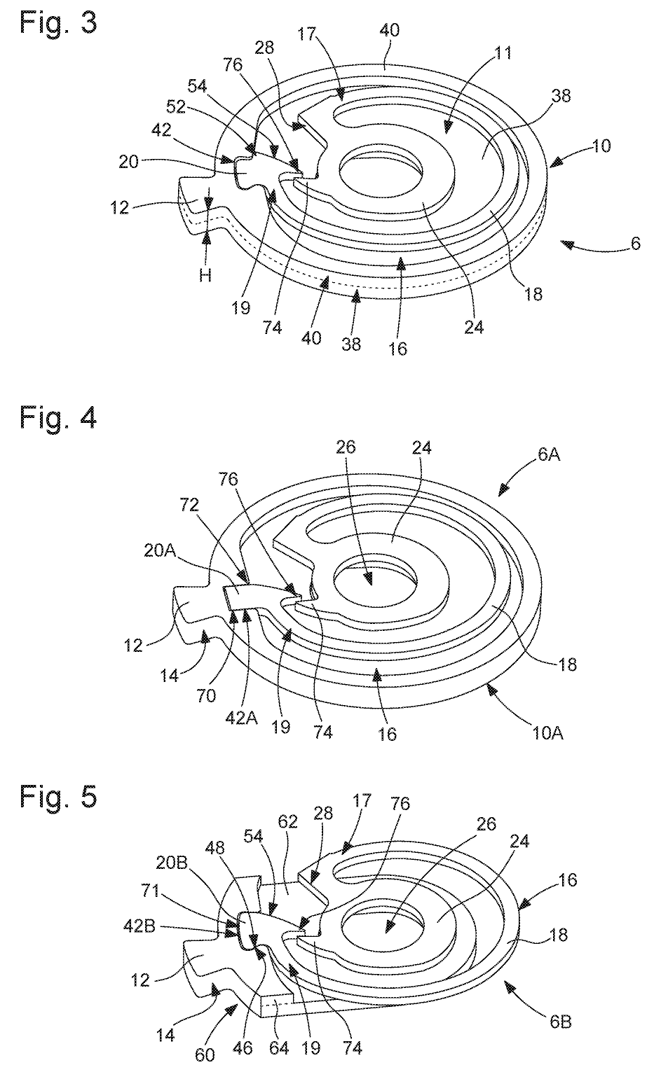

In the first variant shown in FIG. 3, the coupling organ 20 on the mechanism 6 is configured to be able to penetrate at least partially into the bed 42 through the lateral opening, meaning that the coupling organ can be introduced at least partially into the bed 42 from the inner space 11. Moreover, the bed 42 advantageously has a lateral surface 46 oriented obliquely in the direction of rotation 50 (first direction of rotation) of the wheel plate 8, designed to drive the indicator 4 in said first direction, relative to a radial direction, in the configuration in which the spring contracts as it is being loaded, running through the centre of the lateral surface, and the coupling organ 20 has a lateral flank 48, facing the lateral surface, that is also inclined obliquely in the same direction as the lateral surface and that bears at least partially against the lateral surface each time the spring 16 contracts as it is being loaded in order to drive the jumping indicator by the mechanism 6 in the first direction. This particular characteristic makes it possible to ensure that the coupling organ is precisely held in a given drive position inside the bed as soon as the spring contracts as it is being loaded before the date disc 4 jumps to the next date at midnight. The contact point or the contact zone of the bed 42 on which the force of the spring is then exerted via the coupling organ 20 therefore does not vary to any great extent when the spring contracts as it is being loaded. Only a slight variation may occur in the initial phase of the spring loading. Moreover, this characteristic limits the possibility that the coupling organ 20 will rotate on itself, although a relatively large angular clearance is provided for this coupling organ in the bed 42, in particular to allow or facilitate lateral introduction of the coupling organ 20 into the bed 42, in particular automatically by rotating the rigid part 10 relative to the spring 16.

Advantageously, the coupling organ and the bed are configured such that the coupling organ 20 can undergo a certain rotation on itself, at least in an initial phase, when the spring is being loaded, in order to then drive the indicator 4 by jumps in said first direction. It will be noted that the coupling organ rotates on itself in a direction corresponding to the first direction of rotation of the wheel plate 8, meaning in the direction of rotation of the wheel plate when the spring contracts as it is being loaded. However, it is essential that the coupling organ 20 stays in the bed 42 when the spring 16 contracts as it is being loaded. Preferably, only a slight rotation occurs in an initial phase when the spring contracts as it is being loaded. In addition to the aforementioned particular characteristic, the coupling organ 20 and the bed 42 are configured to lock the coupling organ against rotation on itself, once it is in place in the bed and, after a slight, expected rotation, in a direction corresponding to the direction of rotation 50 of the wheel plate (expected direction of rotation for the normal indicator drive). To this end, the coupling organ 20 has an outer part, angularly distant from the lateral flank 48, that is relatively close to the back of the bed 42, without touching it, when the spring 16 begins contracting as it is loaded, and/or comprises a heel 52 that bears radially against a wall 41 bordering the bed 42 on the side opposite the lateral surface 46.

In an advantageous variant of the invention, the angular travel of the second end 19 of the spring 16, and thus of the drive finger 12, relative to the first end 17 of this spring, and thus to the wheel plate 8, is limited, when the spring is contracted, by a third stop 28 rotationally attached to the wheel plate. Then, the indicator 4 and the mechanism 6 are arranged such that, when functioning normally, the indicator jumps after said angular travel is stopped by the third stop, defining the end of the spring's contraction while being loaded prior to this jump, and thus corresponds to a defined angular displacement α, meaning one that does not vary over time with successive loading in order to be able to advance the indicator in successive jumps in said first direction. In this advantageous variant, the normal angular displacement between the first and second ends of the spring, when the spring contracts as it is being loaded, corresponds to the defined angular displacement α.

In the variant shown, the coupling organ 20 has a contact surface 54 that runs from the heel 52 in the direction of the axis of rotation 22 and bears against the third stop 28, which stops the rotation of the coupling organ around the axis of rotation, after the spring has finished contracting as it is being loaded, in order to cause the indicator to jump in the first direction. Preferably, the third stop 28 is between the first end 17 of the spring and the rigid disc 24, in the angular extension of the coil 18 of the spring, and is defined by one and the same part forming the rigid disc and the spring. In other words, the stop 28 is formed by a rigid part intermediate between the rigid disc 24 and the coil 18 of the spring 16. It should be noted that it is advantageous for the third stop 28 to be made in one piece with the spring 16 and the coupling organ 20, which defines the contact surface 54.

Once the coupling organ 20 has been assembled to the finger drum 10, with no external stresses and in particular no shock, this coupling organ remains coupled to the finger drum at all times regardless of the state of the mechanism 6, meaning when the spring is in its angular equilibrium position in periods when there is no interaction between the toothing 5 on the indicator 4 and the drive finger 12, in a state in which the spring contracts as it is being loaded before the indicator jumps, and then when the indicator jumps, and also when the spring may be slightly expanded, in particular when the wheel plate 8 is rotated in the second direction of rotation, opposite to the first direction of rotation provided for normally driving the indicator 4, so as to correct, in particular, the data displayed by the indicator. In conclusion, when the horology movement is functioning normally, the coupling organ 20 remains coupled to the finger drum, meaning in place in the bed 42 and thereby attached to the finger drum.

Remarkably, in a preferred variant corresponding to the variant shown, the mechanism 6 is arranged such that, if the coupling organ 20 exits the bed 42 during a shock, this coupling organ cannot move beyond this bed in the first direction of rotation 50 of the wheel plate 8, regardless of the state in which the mechanism was before such a shock. In the event of a shock generating a force on the coupling organ that could potentially result in this coupling organ exiting its bed, which is highly unlikely, the spring is then in a state that enables the coupling organ to be returned to the bed, namely upstream of the bed relative to the drive direction 50. The rigid part and the coupling organ are arranged such that, if the coupling organ 20 is upstream of the bed 42 relative to the drive direction of the wheel plate, the drive of the spring 16 by the wheel plate 8 returns the coupling organ to the bed after the drive finger 12 has come to a stop against a tooth 5a on the indicator 4, in order to make the next scheduled jump and before this next jump of the indicator occurs, so that the indicator does not skip any jumps, the indicator thus continuing to display correct information.

In an advantageous variant, the side of the bed 42 with its opening has a minimum dimension that is slightly smaller than a maximum dimension of the coupling organ perpendicular to the radial direction, relative to the axis of rotation 22 (coincident with the central axis of the rigid disc 24), of the spring in an angular equilibrium state. More generally, the coupling organ and the bed are arranged such that the coupling organ cannot exit the bed by at least one translation relative to the rigid part, meaning without undergoing a rotation on itself (rotation around its geometric centre or centre of mass along an axis parallel to the axis of rotation 22). To fit into the bed through the lateral opening, the coupling organ must therefore rotate slightly on itself, which is provided for firstly by the profile of the axial wall 40 of the rigid part 10 and secondly by the profile of the coupling organ. This specific characteristic ensures that once the coupling organ has been adequately inserted into the bed 42 and is thus in place, there is very little risk of it exiting the bed, although this is not impossible in exceptional cases, in the event of specific shocks.

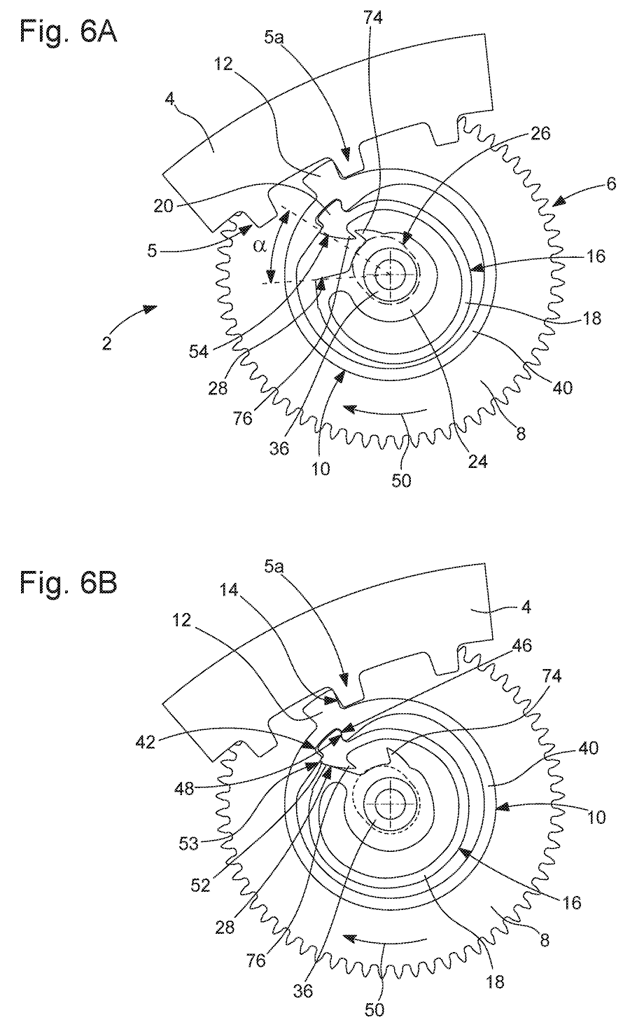

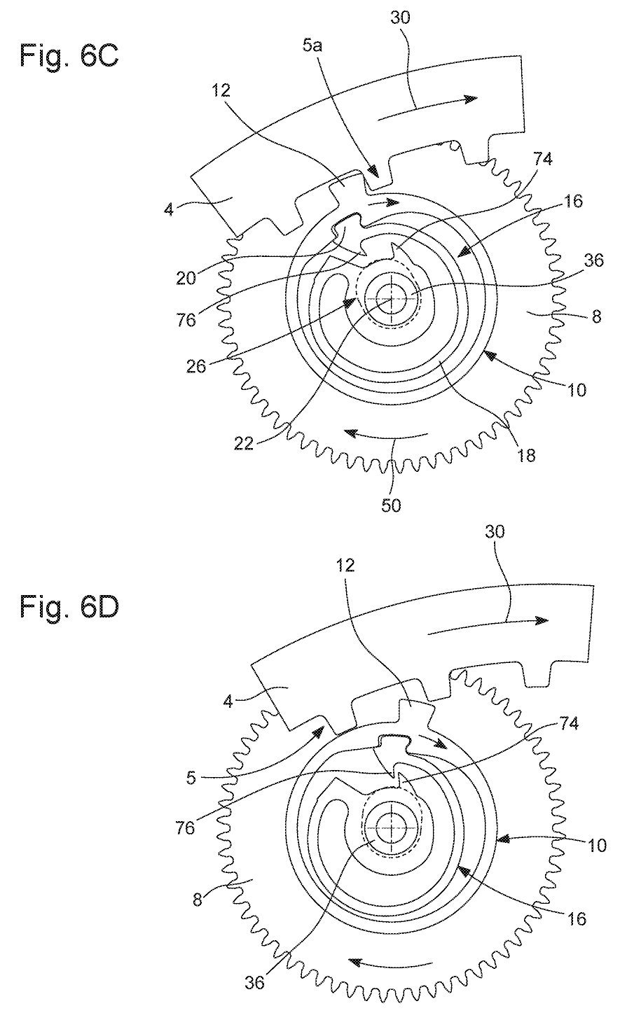

The functioning of the first embodiment of a horology movement, more specifically of the mechanism 6 for driving a date disc 4, and other particular characteristics of the first embodiment will be described in greater detail below, with reference to FIGS. 6A to 9B. It should be noted that, in FIGS. 6A to 9B, the plate 38 on the finger drum 10 is not shown in order to better illustrate the elements in the inner space 11 of this finger drum.

FIGS. 6A to 6D show four successive states of the mechanism 6 for driving the date disc 4 in jumps, in particular semi-instantaneous jumps, in the first direction 30 of the expected rotational movement. These FIGS. 6A to 6D show the mechanism 6 and the date disc 4, when this disc is driven to transition to the next date at midnight, respectively:

When the drive finger 12 comes into contact with a tooth 5a on the date disc 4 and the spring 16 is substantially in angular equilibrium (meaning not angularly tensioned);

After the spring 16 has been loaded, when the contact surface 54 of the coupling organ 20 bears against the third stop 28 after having undergone the angular displacement α relative to the wheel plate 8, this angular displacement being defined by the third stop and the angular position of the coupling organ when the spring is in the equilibrium position;

When the date disc jumps when the mechanical energy stored in the contracted spring is applied to the finger drum 10;

At the end of the jump, when the date disc has substantially reached its next stable position to which it is precisely brought by a jumper spring for positioning the date disc.

It should be noted that, in order to prevent a tooth 5a on the indicator 4 from being able to go over or under the drive finger 12 when the indicator is driven, it is provided that the height between the wheel plate 8 and the underside of the teeth 5, including the clearance, remains constantly located between the lower height and the upper height of the drive finger relative to the wheel plate, including clearance. To this end, in an advantageous variant, the distance between the wheel plate 8 and the underside of the drive finger 12 is less than the thickness of the teeth on the toothing 5. Preferably, in a watch incorporating the horology movement 2, the distance between the upper surface of the drive finger and a component or dial covering the indicator is also designed to be smaller than the thickness of the teeth on the toothing 5. The significant height of the finger 12, which can advantageously rise from at least the bottom of the spring 16 to above the plate 38, which defines the upper surface of the mechanism 6, makes it easy to avoid passing a tooth 5a under or on the drive finger 12.

The mechanism 6 is arranged such that the spring 16 contracts as it is being loaded so as to be able to generate a jump, in particular a semi-instantaneous jump, of the date disc 4 in the first direction 30 of its rotational movement. Moreover, any angular travel of the drive finger 12, and thus of the second end 19 of the spring, relative to the wheel plate 8 and thus to the first end 17 of the spring, is limited, when the coil 18 is contracted after the spring has been loaded, by the third stop 28 which is rotationally attached to the wheel plate 8. Preferably, the indicator and the mechanism are arranged so that, when functioning normally, the indicator 4 jumps after the angular travel is stopped by the third stop 28, when the spring has been fully loaded prior to this jump, and then corresponds to an invariable angular displacement α. It should be noted that in a less advantageous alternative variant, when functioning normally, the indicator jumps before said angular travel is stopped by the third stop 28. In this case, the third stop serves to protect the spring in the event of a shock. It should be noted that the energy stored in the spring 16 will be slightly greater than in the variant in which the jump is released by the third stop, as it is necessary to overcome the hold of the jumper spring and propel the indicator by the couple of the spring alone.

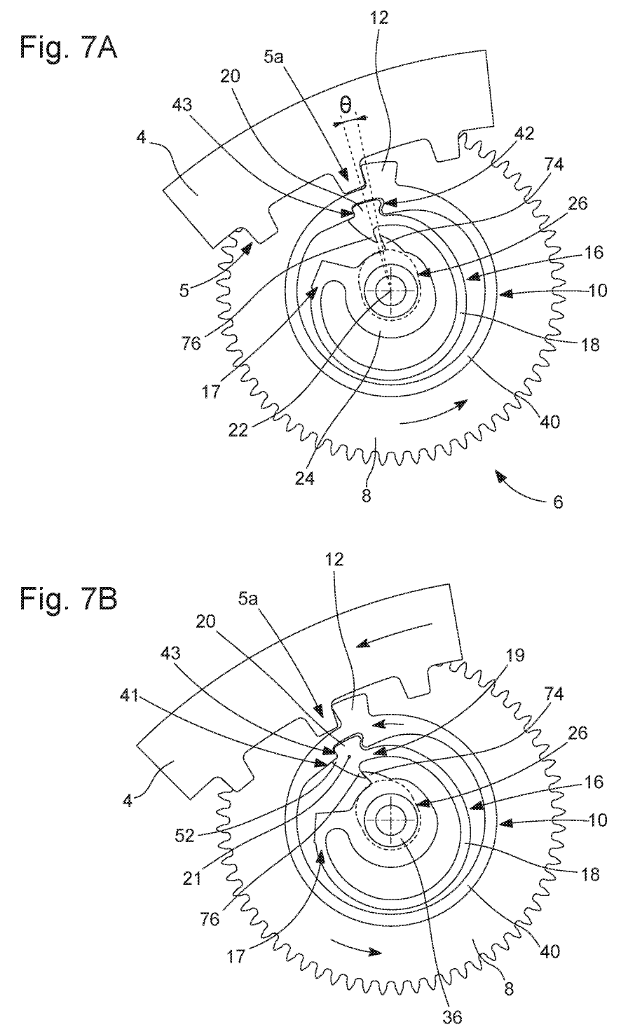

FIGS. 7A and 7B show two successive states of the mechanism 6 that occur when the date disc 4 is driven in said second direction of the expected rotational movement. FIG. 7A shows the mechanism 6 at the moment when the drive finger 12 comes into contact with a tooth 5a on the date disc 4, while the wheel plate 8 is rotating in the second direction of rotation, and when the coupling organ 20 has come into support against a rear lateral surface 43 of the bed 42 and the spring 16 is still in angular equilibrium. In this state, the spring is not angularly tensioned, the first stop 74 and the second stop 76 having an angular lag equal to an initial angular distance θ. This initial angular distance is relatively small so as to achieve one purpose of the invention, which is to significantly limit the expansion of the spring 16 in the mechanism according to the invention, which is arranged so as to be able to rotate the indicator in both directions with the drive finger and to enable a jump drive in said first direction. In the preferred variant as shown in the figures, said initial angular distance θ between the first stop 74 and the second stop 76 is less than a quarter of the angular displacement between these two stops when loading prior to an indicator jump in said first direction, in particular the defined angular displacement α which is fixed and determined by the third stop 28 in the advantageous variant described above and also shown in the figures.

FIG. 7B shows an essentially dragging drive of the indicator 4 in said second direction, while the first stop 74 rotates the second stop 76 and thus the rigid part 10, in particular the drive finger 12. It should be noted that during this dragging drive, after the short initial phase ending when the first stop comes into contact with the second stop 76, the spring 16 is no longer biased to drive the indicator. As soon as the first stop 74 comes into contact with the second stop 76 attached to the coupling organ 20, the slight expansion of the spring 16 ends and the drive finger 12 begins to drive the indicator in said second direction.

According to an advantageous variant of the first embodiment shown in the figures, the second stop 76 is made in one piece with or fastened to the coupling organ 20, which is rigid and has a centre of mass 21 that is radially farther from the axis of rotation 22 than the first stop 74. When the indicator 4 is driven in said second direction by the drive finger, the first stop presses tangentially against the second stop and the coupling organ presses tangentially against a rear wall 43 of the bed 42, this rear wall being radially farther from the axis of rotation 22 than the first stop 74. This generates a first force couple on the coupling organ 20, which causes the coupling organ to rotate on itself in a direction corresponding to the first direction of rotation 50 of the wheel plate 8, and consequently on a terminal part of the coil 18 on the side of the second end 19 of the spring 16. The first force couple is quite high and could cause premature fatigue of said terminal part, or even deterioration of the spring.

Advantageously, the drive mechanism according to the invention tends to relieve the lever arms of the forces that can cause the coupling organ to twist relative to the terminal part 19 of the spring 16 by positioning the forces acting on the coupling organ as close as possible to this terminal part, thereby relieving the lever arms of this force couple. This is made possible in particular by disconnecting the drive finger and the spring 16, which acts to store mechanical energy in order to cause the indicator to jump at a given moment.

In a general variant, in order to prevent said first force couple from being the only force couple applied to the coupling organ 20 when the indicator 4 is driven in said second direction, the coupling organ and the rigid part 10, in particular the bed 42, are configured so as to define, when the indicator is driven in said second direction by the drive finger 12, a brake system providing a second force couple on the coupling organ which opposes any rotation of this coupling organ on itself in a direction corresponding to the first direction of rotation of the wheel plate 8, thus limiting the tensions in the terminal part 19 of the spring.

In an advantageous variant, the coupling organ and the rigid part, in particular the bed, are configured such that said brake system limits said rotation of the coupling organ on itself. In a preferred variant, the coupling organ and the rigid part are arranged such that, at least substantially as soon as the first stop rotates the second stop in said second direction of rotation, the brake system locks the coupling organ against rotation on itself. In particular, as shown in the figures, the brake system is formed at least partially by the heel 52 on the side of the coupling organ opposite the second end 19 of the spring 16 and beyond the centre of mass 21 of this coupling organ, the heel being outside the bed 42 and bearing, when the indicator is driven in said second direction by the drive finger, against the axial surface 41 of the rigid part bordering the bed 42 on the side opposite the side located opposite said terminal part of the spring 16.

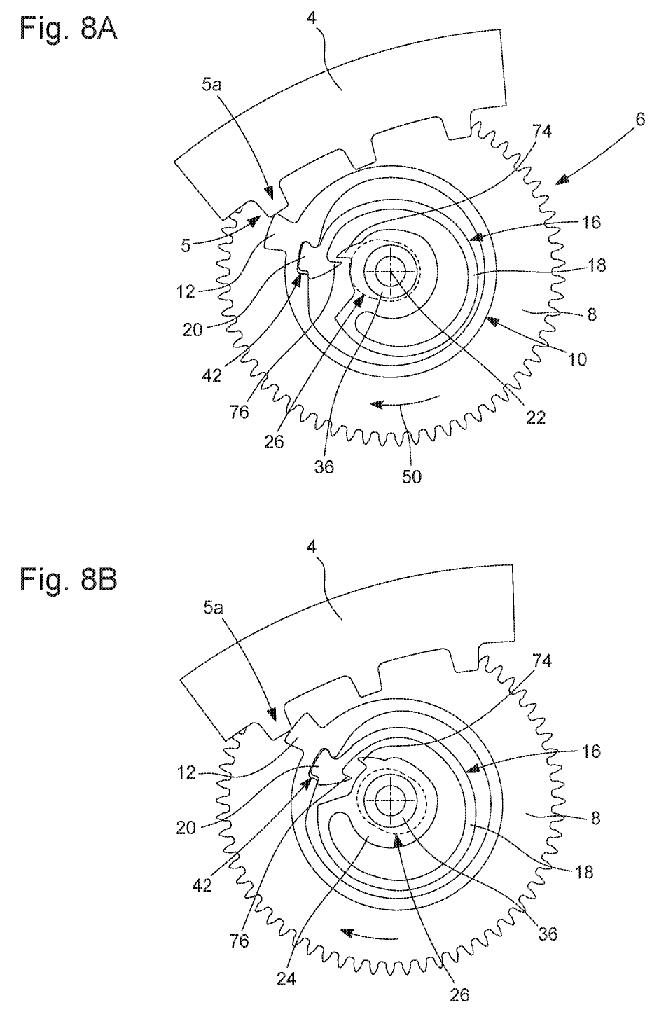

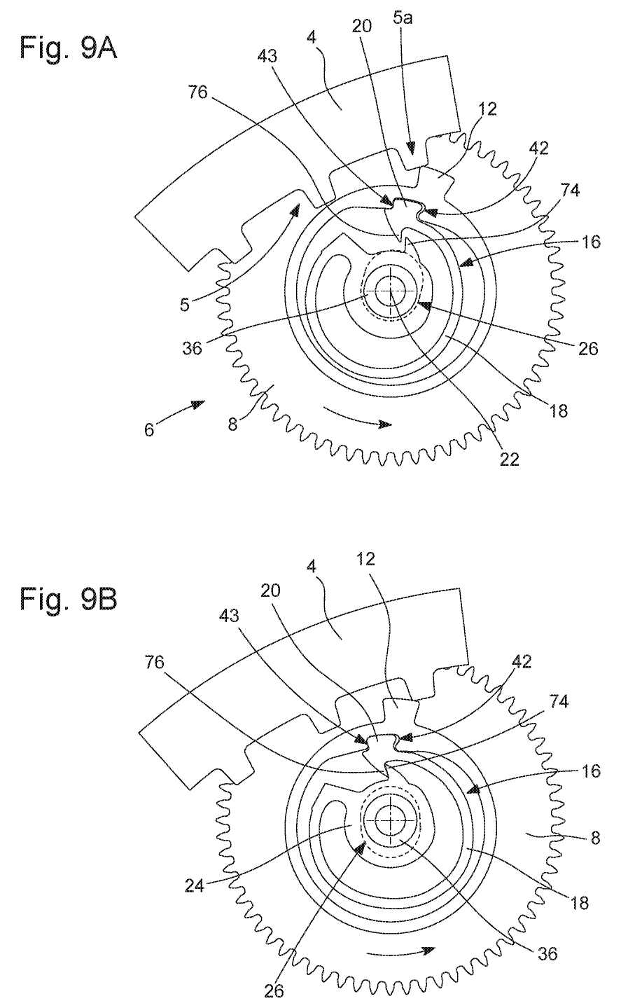

FIGS. 8A to 9B show two situations that can arise for the mechanism 6, when the date disc is not in one of its expected separate and stable positions, in particular as a result of a shock or strong acceleration undergone by the date disc 4. FIGS. 8A and 8B show two successive states of the mechanism 6 as the wheel plate 8 turns in the first direction of rotation 50 and the drive finger 12 comes to a stop against the tangential lateral surface of a tooth 5a on the toothing 5. The rigid part 10 is not only rotationally mobile relative to the wheel plate 8 and rotationally guided around the axis of rotation 22 by an arbor 36, formed by the central part 34, running through an opening in this rigid part, but the rigid part 10 is also translationally mobile due to the fact that the opening is an oblong hole 26 that is configured and in particular oriented to allow the drive finger 12 to be retracted towards the axis of rotation 22 under the action of a radial force exerted by a tooth 5a on the outer lateral surface of this finger, which is for example circular relative to the axis of rotation 22 in the absence of such a radial force. Such retraction is useful for momentarily enabling the drive finger 12 to retract if this finger comes to a stop against the tangential lateral surface of a tooth 5a on the toothing of the indicator 4, in the case of incorrect indexing of the indicator (meaning incorrect angular positioning when stopped), until the drive finger has moved past the tooth 5a in the first direction of rotation 50. FIGS. 9A and 9B show two successive states of the mechanism 6 similar to the ones in FIGS. 8A and 8B, but in the case in which the wheel plate 8 turns in said second direction of rotation, opposite to the first direction, and the drive finger 12 comes to a stop against the tangential lateral surface of a tooth 5a.

FIG. 4 shows a first variant of the first embodiment. The mechanism 6A differs from the previously described mechanism 6 essentially in the configuration of the bed 42A and of the coupling organ 20A turned in this bed on the rigid part 10A. References already described will not be described again here. The bed 42A is substantially square in shape and the coupling organ 20A has an outer part, also substantially square in shape, that is inserted into the bed 42A. The coupling organ 20A is arranged substantially with no angular clearance in the bed, which has a profile defining at least one zone for locking the coupling organ against rotation on itself in a direction corresponding to the first direction of rotation 50 of the wheel plate 8. In the example shown, the bed defines two zones 70 and 72 for locking the member 20A against rotation on itself in a direction corresponding to the first direction of rotation, these two locking zones being substantially aligned in a direction diagonal to the square outer part of the coupling organ located in the bed. Thus, at least substantially as soon as the first stop 74 rotates the second stop 76 in said second direction of rotation, the two locking zones 70 and 72 form a brake system that locks the coupling organ 20A against rotation on itself. It is understood that bed 42A and coupling organ 20A are less sophisticated than bed 42 and coupling organ 20 and are therefore less advantageous. Even if this is not directly apparent, it is easier to fit organ 20 laterally into bed 42 than it is to fit organ 20A into bed 42A when the spring is rotated relative to the rigid part 10A. The organ 20A can then exit the bed 42A if the mechanism 6A undergoes strong acceleration in a radial direction running through the bed 42A, particularly in the event of a shock. Then, in the event of contraction loading, the organ 20A may undergo a slight radial displacement towards the axis of rotation 22, although this is limited by a force couple that is exerted on this coupling organ, relative to its centre of mass, when the spring 16 contracts as it is being loaded when the wheel plate turns in the first direction of rotation 50, and also when the indicator 4 is dragged in said second direction when the wheel plate 8 turns in the second direction of rotation.

FIG. 5 shows a second variant of the first embodiment. Mechanism 6B differs from mechanism 6 described above essentially in that the rigid part 60 no longer forms a finger drum. This rigid part 60 is formed by a plate 62 having an elongated shape along the longitudinal axis of the oblong hole 26 and an axial wall 64 which rises at one end of this plate and in which the bed 42B is machined. The coupling organ 20B has no heel on the side opposite to the second end 19 of the spring 16, but is arranged in the bed 42B with substantially no angular clearance. The lateral surface 46 of the bed 42B and an axial surface 71 at the back of this bed lock the organ 20B against rotation on itself. Thus, at least substantially as soon as the first stop 74 rotates the second stop 76 in said second direction of rotation, the lateral surface 46 and the axial surface 71 form a brake system that locks the coupling organ 20B against rotation on itself in a direction corresponding to the first direction of rotation 50 of the wheel plate 8. The organ 20B might potentially undergo a rotation on itself in a direction corresponding to said second direction of rotation of the wheel plate 8, but this does not pose any particular functional problem as the risk of it exiting the bed in the event of a shock is relatively low and this could facilitate lateral insertion of the coupling organ into the bed 42B.

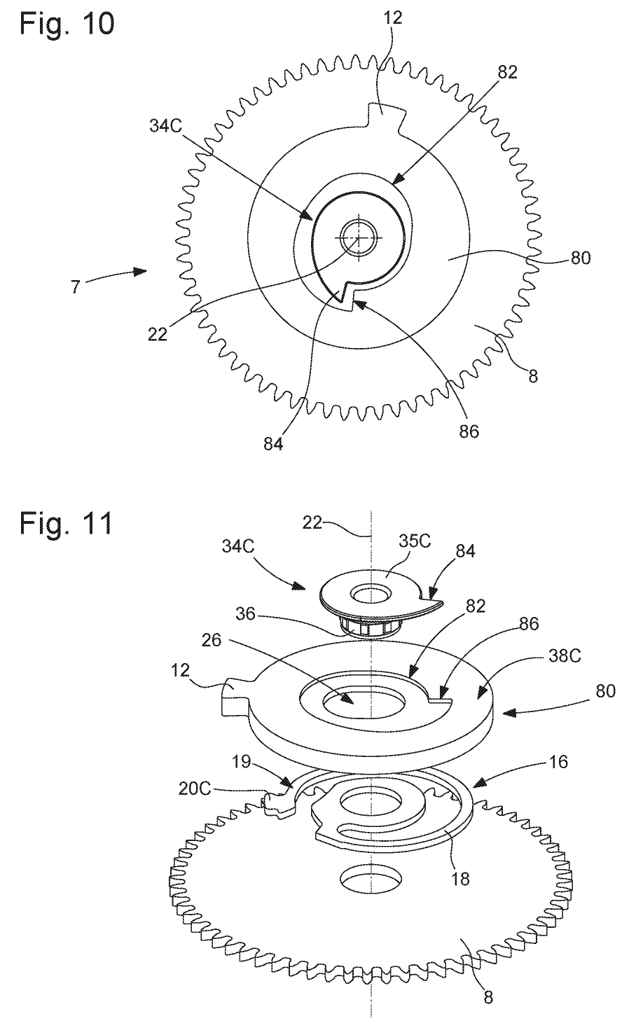

Referring now to FIGS. 10 to 17B, a second embodiment of a horology movement 3 according to the invention will be described, this horology movement comprising a mechanism 7 for driving an indicator 4. References already described will not be described again in detail, but only the differences with the first embodiment will be highlighted. The second embodiment differs from the first embodiment essentially in the arrangement of the first stop 84 and the second stop 86 provided for driving the indicator in said second direction of its movement, meaning in a direction opposite to the first direction that corresponds to the normal functioning direction of the mechanism 7, in particular for displaying the date.

In the second embodiment, the arbor 36 is rotationally attached to the wheel plate 8. Then, in general, the first stop is made in one piece with or fastened to the arbor or with/to a central part rotationally attached to this arbor, and the second stop is formed by the rigid part that comprises the drive finger 12, as defined previously. In the advantageous variant shown, the first stop 84 is defined by the outer profile of a flange 35C that is arranged at one end of a central part 34C forming the arbor 36 and the second stop 86 is defined by the profile/contour of a recess 82 in a plate 38C forming the rigid part 80. More specifically, the first stop 84 is formed by a part of the flange that has an outer axial surface, partially defining the lateral surface of the flange 35C, oriented substantially radially. The flange 35C is located in the recess 82 over at least part of its thickness. The oblong hole 26 is located in the recess 82. Thus, the central part 24C, to which the first end 17 of the spring 16 is fastened, has an outer profile with a single stop 28 (third stop). Similarly, the coupling organ 20C has a different profile to that of the coupling organ 20 described previously, as the second stop 86 is formed by the rigid part 80.

The coupling organ 20C comprises a stop 52 at the rear, which is useful for keeping this coupling organ in the bed 42C in the event of a shock and also for limiting any rotation of this organ 20C on itself, in a direction corresponding to said first direction, when the spring 16 contracts as it is being loaded before the indicator 4 jumps in the first direction 30.

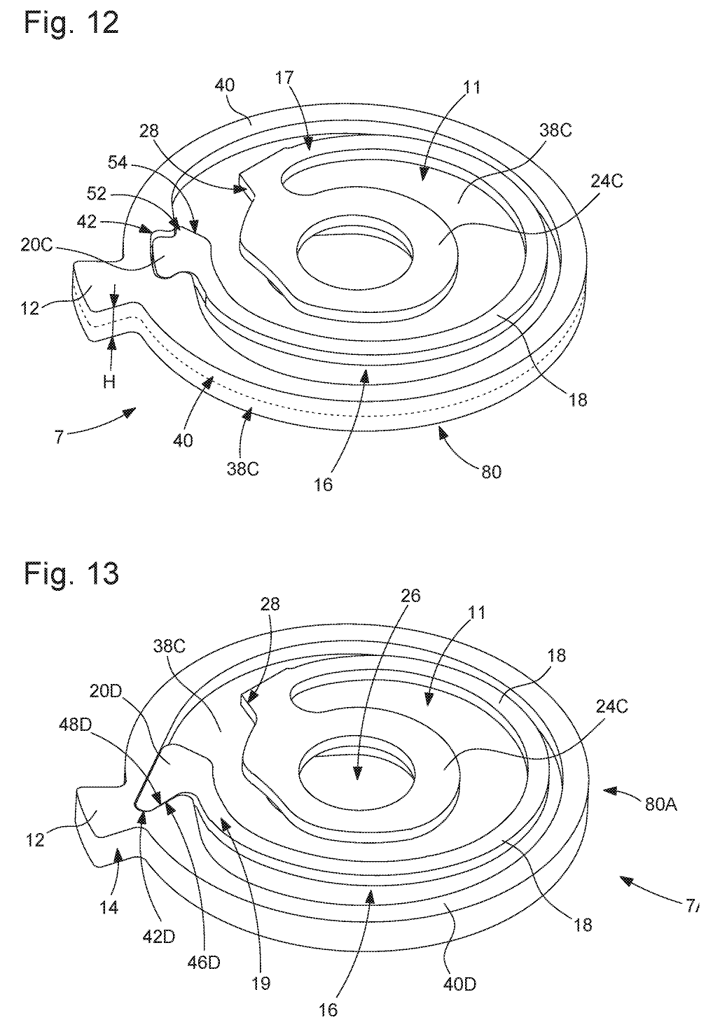

FIG. 13 shows a variant of the second embodiment. This variant does not relate to the arrangement of the first and second stops 84 and 86, which remain identical, but to the arrangement of the coupling organ 20D and of the bed 42D into which the coupling organ is inserted at least when the indicator is driven in jumps in the first direction 30 of its movement. The mechanism 7A differs essentially from the variant shown in FIG. 12 in that the coupling organ 20D has a different shape and the profile of the bed 42D designed to receive it is also different. The bed 42D, which is arranged in the axial wall 40D of the finger drum 80A, is generally triangular in shape and opens progressively towards the inner space 11 of the finger drum in which the spring 16 is arranged. The shape of the part of the coupling organ 20D that is inserted into the bed 42D through the lateral opening corresponds substantially to that of this bed. This configuration enables the coupling organ to be easily inserted into the bed, but would a priori allow this organ to potentially exit it in the event of a shock, although the bed is designed to be relatively deep, with no other means provided to prevent such an event. The means provided in this case to keep the coupling organ in the bed as securely as possible, particularly in the event of a shock, are the shape of the inner part of the coupling organ 20D and the shape of the central part 24C as well as the relative arrangement of this inner part and of this central part. In most potential situations, the inner part of the coupling organ comes to a stop against the central part 24C before the coupling organ 20D completely exits the bed 42D. In addition, the coupling organ is substantially aligned with the longitudinal axis of the oblong hole 26 such that, when it undergoes a substantially radial acceleration and in particular along the longitudinal axis of the bed 42D in the direction of the axis of rotation 22, the finger drum 80A, which is more massive, undergoes the same radial movement in the same direction, which tends to keep the coupling organ in the bed.

Preferably, once inserted in its bed 42D, the coupling organ 20D is kept in place in the bed by the exertion of a force radially from the spring against the axial wall 40D of the finger drum 80A. It should be noted that this radial force is increased when the drive finger is retracted towards the axis of rotation 22 via a radial displacement of the finger drum. The bed 42D advantageously has a lateral surface 46D oriented obliquely in the direction of rotation 50 of the wheel plate 8, designed to drive the indicator 4 in jumps in the first direction 30 (normal functioning direction), relative to a radial direction, in the configuration in which the spring is loaded, running through the centre of this lateral surface, and the coupling organ 20D has a lateral flank 48D, facing the lateral surface, that is also inclined obliquely in the same direction, relative to the axis of rotation 22, as the lateral surface and that bears at least partially against this lateral surface when the spring contracts as it is being loaded and then when the indicator 4 is driven in jumps in the first direction 30 by the mechanism 7A. Moreover, the lateral surface and the lateral flank are advantageously very long. This particular characteristic ensures that the coupling organ is properly held in the bed as soon as the spring 16 is contracted to drive the indicator in jumps in said first direction. In particular, the contact point or contact zone of the bed on which the force of the spring is exerted, via the coupling organ, does not vary while the spring contracts as it is being loaded.

Moreover, the coupling organ 20D cannot rotate on itself, particularly in a direction corresponding to the first direction of rotation of the wheel plate, when the spring contracts as it is being loaded. Lastly, given that the transmission of the force couple to the rigid part 80A by the wheel plate 8, when the indicator is driven in said second direction while the plate is turning in the second direction of rotation opposite to the first direction of rotation, takes place via the first stop 84 that directly rotates the second stop 86 in the second direction of rotation, the spring 16 is not or is only slightly expanded as previously described. The configuration of the bed 42D and of the coupling organ 20D therefore poses no problem, as driving the indicator 4 in said second direction biases neither the spring 16 nor the coupling organ. If the initial angular distance θ is not zero, this initial angular distance is chosen such that the force couple applied to the spring when the indicator 4 is driven in the second direction by the drive finger 12 remains relatively small so that the coupling organ 20D does not move backwards out of the bed 42D, but moves slightly at most, remaining for the most part in the bed. In any case, generally speaking, if the coupling organ 20D were to undergo a backward movement such that it exits the bed, this coupling organ will again easily enter the bed 42D the next time the indicator 4 is turned in said first direction, without skipping a jump in this first direction.

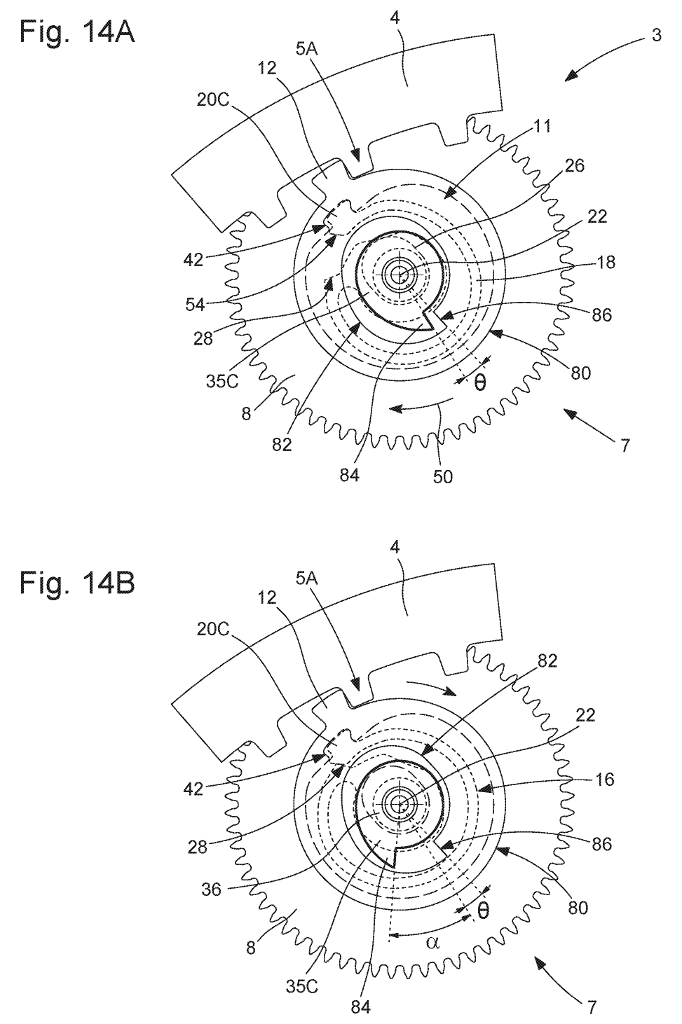

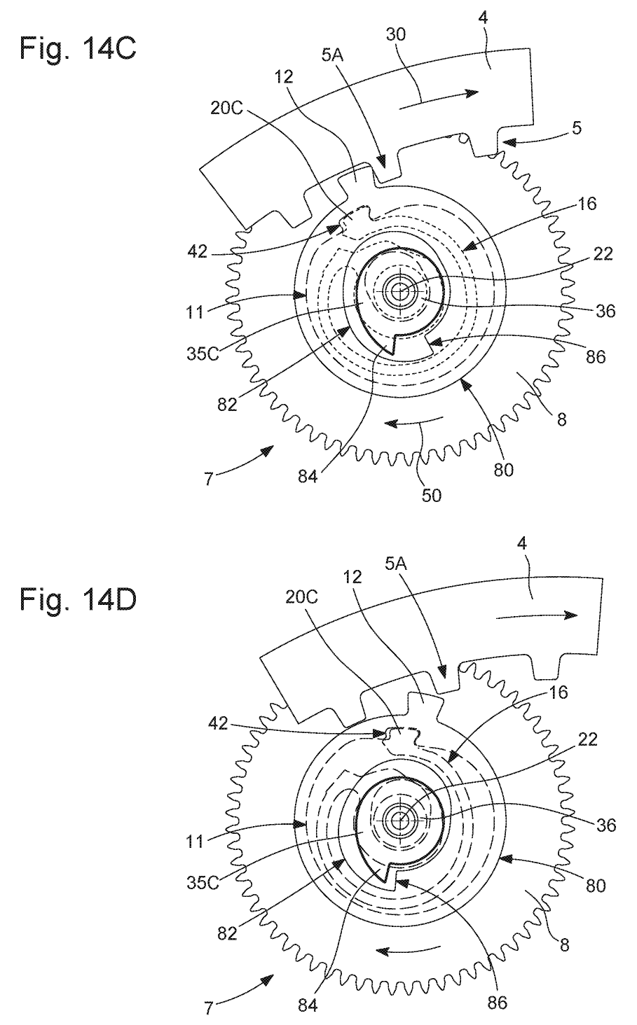

FIGS. 14A to 14D show, as do FIGS. 6A to 6D, four successive states of the mechanism 7 for driving the date disc 4 in jumps, in particular semi-instantaneous jumps, in the first direction 30 of the expected rotational movement. These figures will not be described in greater detail here, as they are clear from what has been said above. It should be noted that, in FIG. 14A, the drive finger 12 has just come into contact with the tooth 5a on the toothing 5 and the spring 16 is still not tensioned (in other words at rest). In this state, the first stop 84 and second stop 86 have a non-zero initial angular distance θ between them. FIG. 14B shows a state in which the spring 16 is fully loaded, the contact surface 54 of the coupling organ 20C having come to a stop against the third stop 28 defined by the central part 24C. FIG. 14B shows the normal angular travel α of the second stop relative to the first stop when the spring contracts as it is being loaded in order to drive the indicator in said first direction. The recess 82 is machined such that angle α of the flange 35C can be rotated from the angular rest position of the spring 16, shown in FIG. 14A.

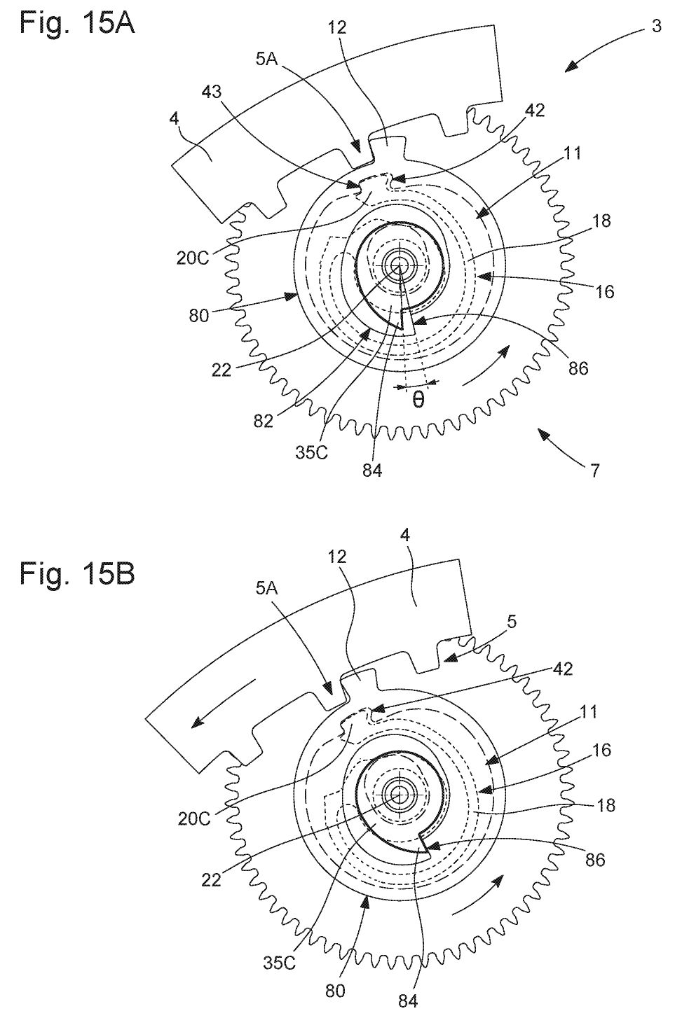

FIGS. 15A and 15B respectively show two states of the mechanism 7 at the start of and during a drive of the indicator in said second direction by the drive finger 12, in particular when the date is corrected in the case of a date indicator 4. The mechanism 7 is arranged so that the first stop 84 rotates the second stop 86 each time the indicator is driven in the second direction by the mechanism, the first stop 84 and the second stop 86 thus limiting or preventing expansion of the spring 16, the initial angular distance θ between the first stop and the second stop, when the drive finger 12 is not in contact with the indicator 4, being less than half of the normal angular displacement α of the second stop relative to the first stop when the spring contracts as it is being loaded to drive the indicator in jumps in said first direction.

In a first variant not shown, the first stop is, as in the variant shown, defined by the outer profile of a flange, attached to a central part forming the arbor 36, and the second stop is formed by a protruding part that rises from the plate forming the rigid part. In a second variant not shown, the first stop and the second stop are arranged in the inner space 11 of the rigid part, the first stop being fastened to or formed by the rigid part and the second stop being fastened to or made in one piece with the wheel plate and protruding therefrom. In particular, the first stop is defined by the inner profile of the axial wall of the rigid part (this axial wall has a modified inner profile, relative to axial wall 40, with a substantially radial surface defining the first stop), and the second stop is formed by a protruding part, for example a pin, rising from the wheel plate 8 into the inner space 11.

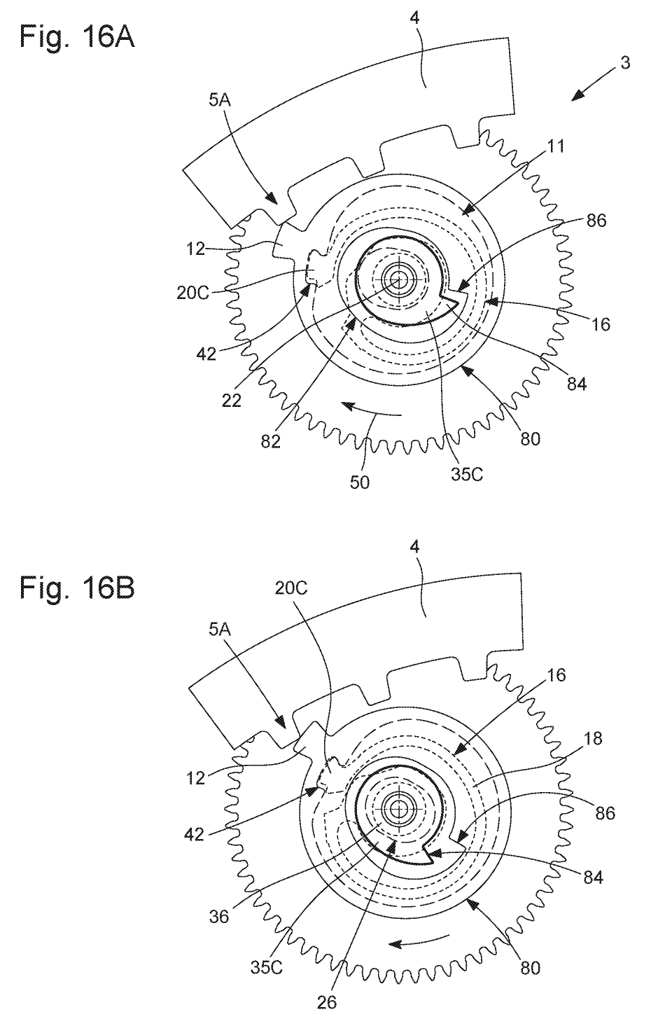

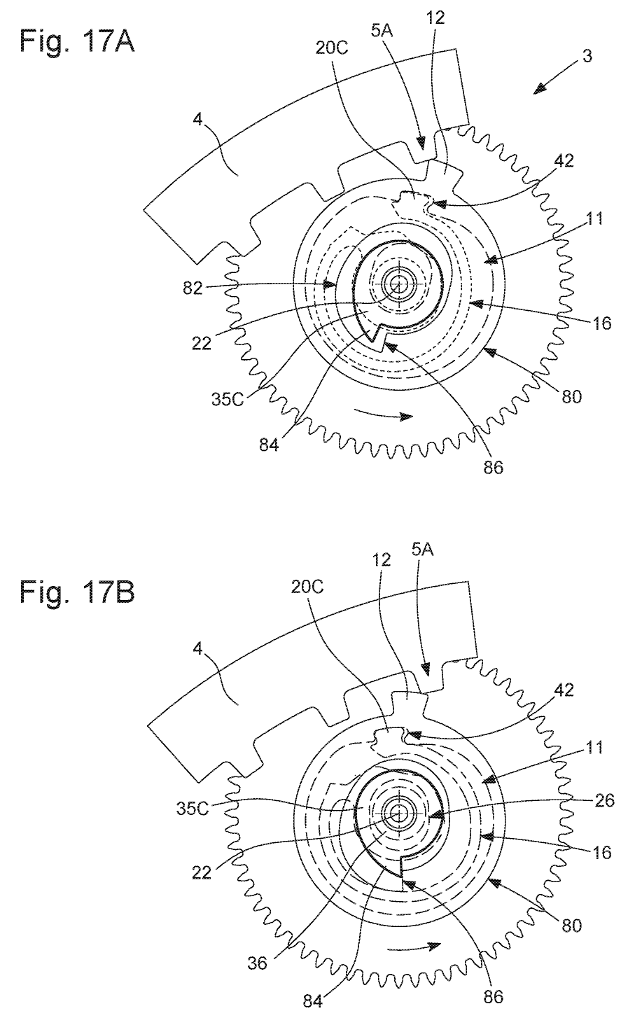

FIGS. 16A and 16B show two states of the mechanism 7 similar to the ones in FIGS. 8A and 8B, in the event of an indexing problem of the date disc 4 (meaning in the case in which this disc is not in a separate stable position defined by its toothing 5 and a positioning jumper spring) when the drive finger 12 arrives at the tangential lateral surfaces of the teeth on the toothing, each tooth 5a having two radial lateral surfaces connected by a tangential lateral surface. Similarly, FIGS. 17A and 17B show the mechanism 7 in two states similar to the ones shown in FIGS. 9A and 9B.

1. A horology movement fitted with an indicator and comprising a mechanism for driving this indicator in a first direction of movement provided for the indicator, the drive being in jumps in the first direction, which corresponds to the direction of movement of the indicator when the horology movement is functioning normally,
the mechanism comprising a wheel plate defining an axis of rotation, a rigid part arranged above the wheel plate and forming a drive finger configured to drive the indicator, and a spring comprising a coil having a first end, rotationally attached to the wheel plate, and a second end rotationally attached to the rigid part at least when the spring is being loaded prior to a jump of the indicator in said first direction and then when the indicator is being driven by the drive finger to execute this jump, the rigid part being rotationally mobile relative to the wheel plate and rotationally guided around said axis of rotation by an arbor aligned with this axis of rotation and running through an opening in the rigid part, and that enables the drive finger to be retracted towards the axis of rotation under the action of a radial component of a force that can be exerted on this drive finger;
wherein the mechanism is arranged so as to be able to drive the indicator, with the drive finger, in said first direction and in a second direction, opposite to the first direction, of movement of the indicator when the wheel plate turns respectively in a first direction of rotation and a second direction of rotation opposite to the first direction of rotation;
wherein the mechanism is arranged such that the spring contracts each time it is loaded in order to then cause the indicator to jump in said first direction; and wherein the mechanism comprises a first stop rotationally attached to the wheel plate and a second stop rotationally attached to the rigid part at least each time the indicator is driven by the drive finger in said second direction,
the mechanism being arranged such that the first stop causes the second stop to rotate each time the indicator is driven in said second direction by the drive finger, the first stop and the second stop thus limiting or preventing expansion of the spring and having an initial angular distance (θ) when the drive finger is not in contact with the indicator, this initial angular distance being less than half of a normal angular displacement (α) of the second stop relative to the first stop when the spring contracts as it is being loaded in order to drive the indicator in said first direction.

2. The horology movement according to claim 1, wherein said initial angular distance (θ) between the first stop and the second stop is less than a quarter of said normal angular displacement (α).

3. The horology movement according to claim 1, wherein, when the drive finger is not in contact with the indicator, the spring is substantially in its equilibrium position.

4. The horology movement according to claim 1, wherein the drive finger has two flanks that are configured so as to be able to engage with a toothing (5) on the indicator to enable the indicator to be driven in said first direction and said second direction, respectively.

5. The horology movement according to claim 1, wherein the angular travel of the second end of the spring, and thus of the drive finger, relative to the first end of this spring, and thus to the wheel plate, is limited, when the spring is contracted, by a third stop which is rotationally attached to the wheel plate; and wherein the indicator and the mechanism are arranged such that, when functioning normally, the indicator jumps after said angular travel is stopped by the third stop, defining the end of a spring loading prior to this jump, and then corresponds to a defined angular displacement (α) corresponding to said normal angular displacement.

6. The horology movement according to claim 1, wherein the mechanism comprises a coupling organ that extends the spring on the side of its second end and that is at least partially inserted into a bed in the rigid part such that the spring is coupled to the rigid part, the coupling organ rotationally attaching the rigid part and the second end of the spring when the spring is being loaded and at least when the indicator is being driven in said first direction by the drive finger.

7. The horology movement according to claim 6, wherein the coupling organ and the bed are configured such that this coupling organ can be rotated on itself to a certain extent, at least in an initial phase, when the spring is being loaded, in order to drive the indicator in said first direction.

8. The horology movement according to claim 6, wherein said arbor is rotationally attached to the wheel plate and the coupling organ is rotationally attached to the rigid part when the indicator is driven in said second direction by the drive finger; and wherein the first stop is made in one piece with or fastened to said arbor or with / to a central part rotationally attached to said arbor, and the second stop is made in one piece with or fastened to the spring, on the side of its second end, or with / to the coupling organ.

9. The horology movement according to claim 8, in which the second stop is made in one piece with or fastened to the coupling organ; wherein the coupling organ has a centre of mass that is radially farther from said axis of rotation than the first stop; wherein, when the indicator is driven in said second direction by the drive finger, the first stop presses tangentially against the second stop and the coupling organ presses tangentially against a rear wall of the bed, this rear wall being radially farther from the axis of rotation than the first stop; and wherein the coupling organ and the rigid part, in particular the bed, are configured such that, when the indicator is driven in said second direction by the drive finger, they define a brake system providing a force couple on the coupling organ that opposes any rotation of the coupling organ on itself in a direction corresponding to the first direction of rotation of the wheel plate.

10. The horology movement according to claim 9, wherein the coupling organ and the rigid part, in particular the bed, are configured such that said brake system limits said rotation of the coupling organ on itself.

11. The horology movement according to claim 9, wherein the coupling organ and the rigid part are arranged such that, at least substantially as soon as the first stop rotates the second stop in said second direction, the brake system locks the coupling organ against rotation on itself.

12. The horology movement according to claim 9, wherein the brake system is formed at least partially by a heel that the coupling organ has on the side opposite the second end of the spring and beyond a centre of mass of this coupling organ, the heel being outside the bed and bearing against an axial surface on the rigid part bordering the bed when the indicator is driven in the second direction by the drive finger.

13. The horology movement according to claim 10; wherein the coupling organ is arranged with substantially no angular clearance in the bed, which has a profile defining at least one zone for rotationally locking the coupling organ in the bed in a direction corresponding to said first direction of rotation of the wheel plate.

14. The horology movement according to claim 1; in which said arbor is rotationally attached to the wheel plate; wherein the first stop is made in one piece with or fastened to the arbor or with/to a central part rotationally attached to this arbor, and the second stop is formed by the rigid part.

15. The horology movement according to claim 14; wherein the first stop is defined by the outer profile of a flange arranged at one end of a central part, which forms said arbor, and the second stop is defined by the profile of a recess in a plate forming the rigid part, the flange being located in the recess over at least part of its thickness.

16. The horology movement according to claim 14; wherein the first stop is defined by the outer profile of a flange, attached to a central part forming the arbor, and the second stop is formed by a protruding part that rises from a plate forming the rigid part.

17. The horology movement according to claim 14; wherein the first stop and the second stop are arranged in the inner space of the rigid part, the first stop being fastened to or formed by said rigid part and the second stop being fastened to or made in one piece with the wheel plate and protruding therefrom.

18. The horology movement according to claim 17, wherein said opening is an oblong hole machined in a plate forming the rigid part.

19. The horology movement according to claim 15, wherein said opening is an oblong hole machined in the plate.

20. The horology movement according to claim 16, wherein said opening is an oblong hole machined in the plate.

21. The horology movement according to claim 1, wherein the indicator is a minute, hour, date, day or month indicator.
